(19) United States
(12) Patent Application Publication
(10) Pub. No.: US 2026/0336117 A1
(43) Pub. Date: Oct. 29, 2026

(54) ROBOT SYSTEM, ROBOT CONTROLLER, AND CONTROL METHOD

(71) Applicant: KABUSHIKI KAISHA YASKAWA DENKI, Kitakyushu-shi (JP)

(72) Inventor: Junya YOSHIDA, Fukuoka (JP)

(73) Assignee: KABUSHIKI KAISHA YASKAWA DENKI, Kitakyushu-shi (JP)

(21) Appl. No.: 19/653,122

(22) Filed: Apr. 21, 2026

(30) Foreign Application Priority Data
Apr. 25, 2025 (JP) 2025-073676

(51) Int. Cl. B25J 9/16

(52) U.S. Cl. CPC B25J 9/1671

(57) ABSTRACT

A robot system includes an articulated robot configured to move, relative to a workpiece, an end effector configured to execute a predetermined process on the workpiece, and circuitry configured to control the articulated robot based on a plurality of target positions stored in advance, execute a simulation of an unexecuted motion by the articulated robot based on at least one of the plurality of target positions and estimate a timing for outputting an execution command of the process based on a result of the simulation, output the execution command based on the estimated timing, and cause the end effector to execute the process in response to the execution command.

### CROSS-REFERENCE TO RELATED APPLICATIONS

This application is based upon and claims the benefit of priority from Japanese Patent Application No. 2025-073676, filed on Apr. 25, 2025, the entire contents of which are incorporated herein by reference.

### BACKGROUND

### Field

The present disclosure relates to a robot system, a robot controller, and a control method.

### Description of the Related Art

Japanese Unexamined Patent Publication No. 2023-034483 discloses a robot system including an articulated robot arm including a plurality of joints, a working unit that performs work on a workpiece, a signal output unit that outputs a signal based on a relative movement amount of the working unit for each relative movement amount of the working unit with respect to the workpiece, and a work control unit that controls work performed by the working unit on the workpiece based on a signal output from the signal output unit.

### SUMMARY

Disclosed herein is a robot system. The robot system may include: an articulated robot configured to move, relative to a workpiece, an end effector configured to execute a predetermined process on the workpiece; and circuitry configured to control the articulated robot based on a plurality of target positions stored in advance, execute a simulation of an unexecuted motion by the articulated robot based on at least one of the plurality of target positions and estimate a timing for outputting an execution command of the process based on a result of the simulation, output the execution command based on the estimated timing, and cause the end effector to execute the process in response to the execution command.

Additionally, a robot controller is disclosed herein. The robot controller may include circuitry configured to control an articulated robot based on a plurality of target positions stored in advance so as to move, relative to a workpiece, an end effector that executes a predetermined process on the workpiece, execute a simulation of an unexecuted motion by the articulated robot based on at least one of the plurality of target positions and estimate a timing for outputting an execution command of the process based on a result of the simulation, and output the execution command based on the estimated timing.

Additionally, a control method is disclosed herein. The control method may include controlling an articulated robot based on a plurality of target positions stored in advance so as to move, relative to a workpiece, an end effector that executes a predetermined process on the workpiece, executing a simulation of an unexecuted motion by the articulated robot based on at least one of the plurality of target positions and estimating a timing for outputting an execution command of the process based on a result of the simulation, and outputting the execution command based on the estimated timing.

### BRIEF DESCRIPTION OF THE DRAWINGS

FIG. 1 is a schematic diagram illustrating an example configuration of a robot system.

FIGS. 2A, 2B, and 2C are diagrams illustrating an example relationship between elapsed time and a position of an end effector.

FIG. 3 is a diagram illustrating an example estimation of command timings for a plurality of processing positions.

FIG. 4 is a diagram illustrating an example estimation of an arrival position of an end effector in cycle process.

FIG. 5 is a diagram illustrating an example relationship between elapsed time and an estimation result of a movement speed.

FIG. 6 is a diagram illustrating a modification of a robot controller.

FIG. 7 is a block diagram illustrating an example hardware configuration of the robot controller.

FIG. 8 is a flowchart illustrating an example control procedure for an articulated robot.

FIG. 9 is a flowchart illustrating an example control procedure for a joint.

FIG. 10 is a flowchart illustrating an example estimation procedure for a command timing.

FIG. 11 is a flowchart illustrating an example execution command output procedure.

FIG. 12 is a flowchart illustrating an example control procedure for an end effector.

### DETAILED DESCRIPTION

In the following description, with reference to the drawings, the same reference numbers are assigned to the same components or to similar components having the same function, and overlapping description is omitted.

### Robot System

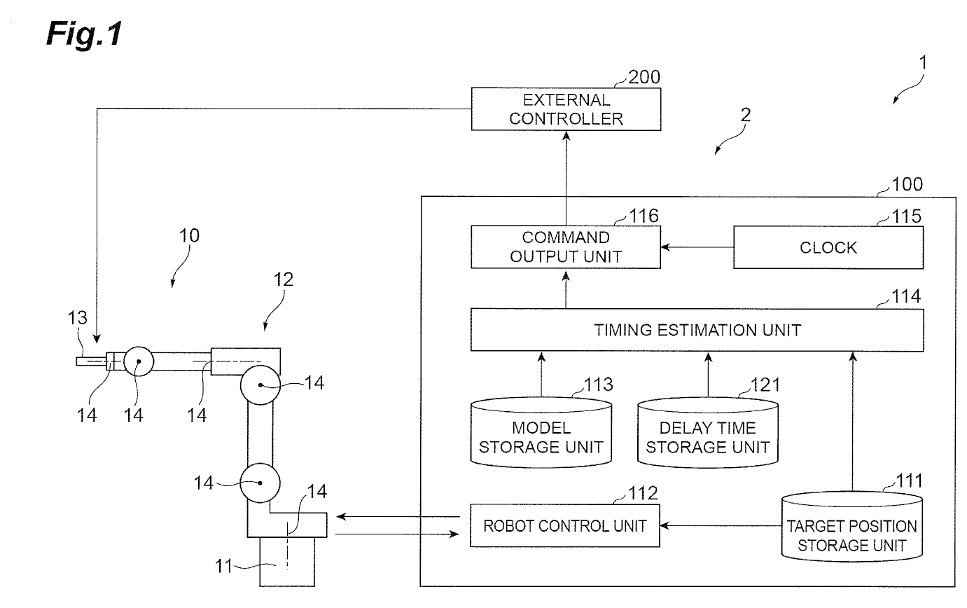

The robot system 1 illustrated in FIG. 1 is a system that causes an articulated robot 10 to execute predetermined work on a workpiece. The articulated robot 10 moves an end effector 13 that executes a predetermined process on a workpiece, relative to the workpiece. The end effector 13 is configured to execute the predetermined process. Examples of the process include application of paint, irradiation of light, and acquisition of information on a surface of a workpiece. Examples of acquisition of information on a surface of a workpiece include measurement of a distance to the surface of the workpiece and acquisition of image information of the surface of the workpiece. For example, the end effector 13 may be an ink head that intermittently ejects paint, may be an irradiation device that irradiates processing light such as laser light, may be a distance sensor of a TOF method or a triangulation method, or may be an imaging device. The end effector 13 may be a line sensor for acquiring image information of a surface of a workpiece by a line scan method.

As illustrated in FIG. 1, the robot system 1 includes an articulated robot 10 and a control system 2. The articulated robot 10 is, for example, an industrial vertical articulated robot, and includes a base 11, an arm 12, and an end effector 13. The base 11 is fixed to a floor surface, a wall surface, a ceiling surface, or the like of a work place of the articulated robot 10. The arm 12 is of a serial link type having a plurality of (for example, six) joints 14, and is connected to the base 11. The end effector 13 is connected to an end of the arm 12 and acts on the workpiece in work performed by the articulated robot 10. The arm 12 changes the position of the end effector 13 by moving the plurality of joints 14. Changing the position of the end effector 13 includes changing the posture of the end effector 13.

The control system 2 controls the articulated robot 10 so as to move the end effector 13, and controls the end effector 13 so as to execute the process. The control system 2 may cause the end effector 13 to execute the process while moving the end effector 13 by the articulated robot 10. In order to execute the process at a desired position on the workpiece, it may be beneficial to accurately control the position at which the process is executed by the end effector 13. In particular, when causing the end effector 13 to execute the process while moving the end effector 13 by the articulated robot 10, accurately controlling the execution timing of the process helps ensure that the position at which the process is executed by the end effector 13 does not deviate from a desired position (a position at which the process is desired to be executed).

Therefore, the control system 2 is configured to execute: controlling the articulated robot 10 based on a plurality of target positions stored in advance; executing a simulation of an unexecuted motion based on at least one of the plurality of target positions and estimating a timing for outputting an execution command of the process based on a result of the simulation (hereinafter referred to as "command timing"); outputting the execution command based on the estimated command timing; and causing the end effector 13 to execute the process in response to the execution command.

When causing the end effector 13 to execute the process after detecting that the end effector 13 has reached a desired position, a delay may occur between the timing at which the end effector 13 actually reaches the desired position and the timing at which the process is executed. Due to this delay, there is a possibility that the position of the process executed by the end effector 13 cannot be accurately controlled. With the control system 2, before the end effector 13 reaches the position at which the process is desired to be executed, the timing for outputting the execution command of the process is estimated by simulation, and the execution command is output based on the estimated timing. For example, the estimated timing is set to be before the actual arrival of the end effector 13 at the processing position EP. This reduces an error between the actual execution position of the process and the processing position EP, compared with a case where the execution command is output in response to detection of the actual arrival of the end effector 13 at the processing position EP. Therefore, the position of the process executed by the end effector 13 can be more accurately controlled.

For example, the control system 2 includes a robot controller 100 and an external controller 200. The robot controller 100 controls the articulated robot 10 so as to move the end effector 13, and outputs the execution command described above. The external controller 200 (end effector control unit) causes the end effector 13 to execute the process in response to the execution command.

The robot controller 100 includes, as functional components (hereinafter referred to as "functional blocks"), a target position storage unit 111, a robot control unit 112, a model storage unit 113, a timing estimation unit 114, a clock 115, and a command output unit 116. The target position storage unit 111 stores a plurality of target positions arranged in time series. Each of the plurality of target positions represents a target position of the end effector 13. The target position of the end effector 13 includes a target posture of the end effector 13.

The target position may be data that directly defines the target position of the end effector 13, or may be data that indirectly defines the target position of the end effector 13. For example, the target position may be data that defines a target angle of each of the plurality of joints 14. The target position of the end effector 13 is uniquely determined by the target angle of each of the plurality of joints 14. For example, the target position of the end effector 13 is uniquely determined by a forward kinematics calculation based on the target angle of each of the plurality of joints 14 and DH (Denavit-Hartenberg) parameters of the articulated robot 10.

The robot control unit 112 controls the articulated robot 10 based on the plurality of target positions stored in advance in the target position storage unit 111. For example, the robot control unit 112 operates each of the plurality of joints 14 so as to sequentially move the end effector 13 to the plurality of target positions arranged in time series.

The model storage unit 113 stores a simulation model of the articulated robot 10. The simulation model is a model for simulating the motion of the articulated robot 10, and is numerical data representing structural characteristics, dynamic characteristics, and the like of the articulated robot 10.

The timing estimation unit 114 executes a simulation of an unexecuted motion based on at least one of the plurality of target positions, and estimates a timing for outputting an execution command of the process based on a result of the simulation (hereinafter referred to as "command timing"). The timing estimation unit 114 may estimate the command timing so that an error between a position at which the process is executed by the end effector 13 and a predetermined processing position is reduced. By predetermining the processing position, the position at which the process is executed can be controlled. Predetermining the processing position includes predetermining the processing position before the articulated robot 10 operates, and determining the processing position in real time based on surrounding environment information or the like while the articulated robot 10 is operating. It is sufficient that the processing position is determined at least before the end effector 13 reaches that position.

For example, the timing estimation unit 114 estimates a movement trajectory (temporal change of position) of the end effector 13 in the unexecuted motion based on one or more unexecuted target positions among the plurality of target positions and the simulation model stored in the model storage unit 113. The timing estimation unit 114 estimates a timing at which the end effector 13 reaches the processing position (hereinafter referred to as "arrival timing") based on the estimated temporal change of the position of the end effector 13, and estimates the command timing based on the estimated arrival timing.

The clock 115 measures elapsed time. For example, the clock 115 measures elapsed time by counting clock pulses for timekeeping.

The command output unit 116 outputs the execution command based on the command timing estimated by the timing estimation unit 114. For example, the command output unit 116 outputs the execution command when the elapsed time measured by the clock 115 reaches the command timing.

The robot controller 100 may further include a delay time storage unit 121. The delay time storage unit 121 stores a delay time from the output of the execution command to the execution of the process by the end effector 13. The timing estimation unit 114 may estimate the command timing further based on the delay time stored in the delay time storage unit 121. A deviation in the position at which the process is executed by the end effector 13 can be further suppressed.

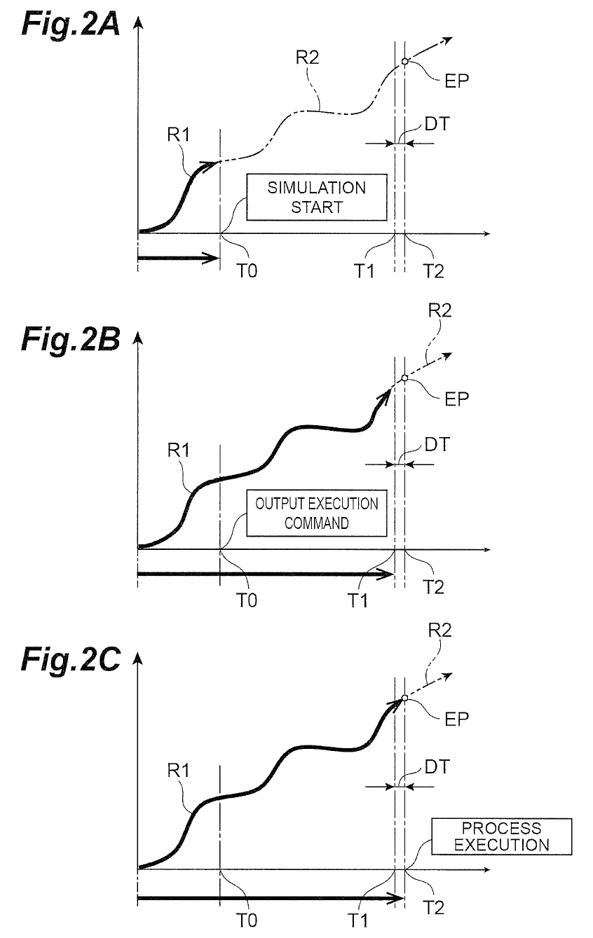

FIGS. 2A, 2B, and 2C are graphs schematically illustrating a relationship between elapsed time and the position of the end effector 13. The horizontal axes of FIGS. 2A, 2B, and 2C represent elapsed time, and the vertical axes of FIGS. 2A, 2B, and 2C represent the position of the end effector 13. As illustrated in FIG. 2A, the timing estimation unit 114 starts the simulation at a predetermined estimation start timing T0. There is no particular limitation on the estimation start timing T0. The estimation start timing T0 may be a timing at which the articulated robot 10 starts its motion, or may be a timing at which the end effector 13 reaches a predetermined target position. The estimation start timing T0 may also be a timing at which an issuing unit 133, described later, issues a predetermined target position. The timing estimation unit 114 estimates a movement trajectory R2 of the position of the end effector 13 that follows a movement trajectory R1 of the position of the end effector 13 up to the estimation start timing T0, based on the target positions after the estimation start timing T0 and the simulation model. The timing estimation unit 114 estimates an arrival timing T2 at which the end effector 13 reaches the processing position EP based on the estimation result of the movement trajectory R2, and estimates a time that is earlier than the arrival timing T2 by the delay time DT as the command timing T1.

Thereafter, as illustrated in FIG. 2B, when the elapsed time reaches the command timing T1, the command output unit 116 outputs the execution command. As illustrated in FIG. 2C, the external controller 200 causes the end effector 13 to execute the process at a timing delayed from the command timing T1 by the delay time DT. As described above, since the command timing T1 is set to a time earlier than the arrival timing T2 by the delay time DT, a length of time from the command timing T1 to the arrival timing T2 corresponds to the delay time DT, and the timing at which the end effector 13 executes the process substantially coincides with the timing at which the end effector 13 reaches the processing position EP.

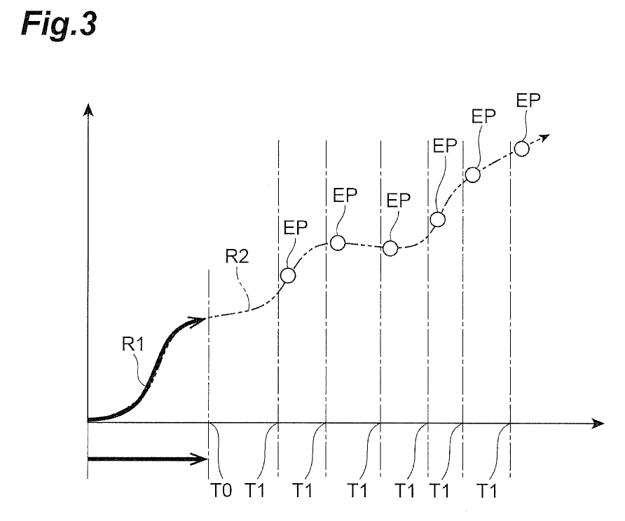

As illustrated in FIG. 3, the timing estimation unit 114 may estimate the command timing T1 for each of the plurality of processing positions EP. The plurality of processing positions EP are arranged, for example, at equal intervals along the movement trajectory R2. The command output unit 116 may output the execution command based on the command timing T1 estimated for each of the plurality of processing positions EP. The magnitude of the deviation of the position at which the end effector 13 actually executes the process (hereinafter referred to as "execution position") with respect to the processing position varies due to the delay described above and due to the movement speed of the end effector 13, so the magnitude of the deviation may vary for each processing position. For this reason, even if the plurality of processing positions are arranged at equal intervals and the same delay occurs for each of the plurality of processing positions, the intervals between the plurality of execution positions may vary due to changes in the movement speed of the end effector 13. With this robot system 1, which can significantly reduce the delay from the timing at which the end effector 13 reaches the processing position to the timing at which the process is executed, variation in the intervals between the plurality of execution positions can be suppressed.

For example, when the robot system 1 performs printing on a workpiece by ejecting paint from the end effector 13 while moving the end effector 13 by the articulated robot 10, variation in the intervals between the plurality of execution positions can be suppressed, thereby suppressing distortion of the printing result. When the robot system 1 performs a line scan for imaging a workpiece while moving the end effector 13 by the articulated robot 10, variation in the intervals between the plurality of execution positions can be suppressed, thereby suppressing distortion of the imaging result.

The robot control unit 112 may execute cycle process for controlling the articulated robot 10 based on each of the plurality of target positions. For example, each of the plurality of target positions may be a target position for each cycle process that the robot control unit 112 repeats at a constant control cycle. The timing estimation unit 114 may execute a simulation based on the target position of an unexecuted cycle process and a model of the articulated robot 10, and estimate the command timing in the unexecuted cycle process based on a result of the simulation. Since the timing can be estimated by executing a simulation of future behavior for each cycle process, the position of the process executed by the end effector 13 can be more accurately controlled.

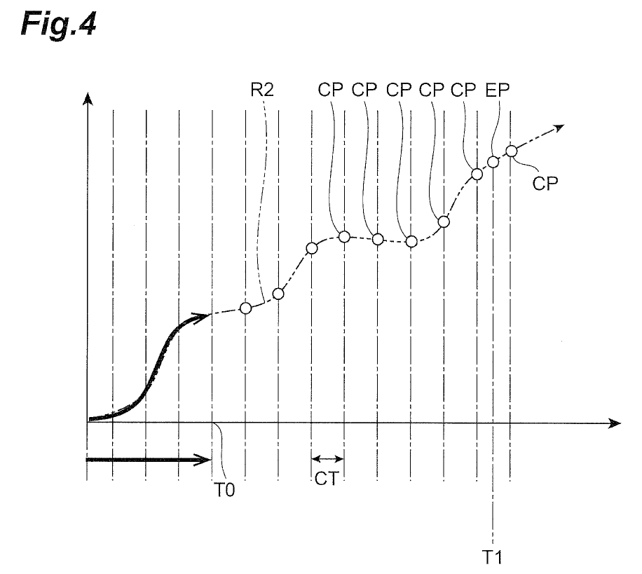

For example, as illustrated in FIG. 4, the timing estimation unit 114 repeats the cycle process at a constant control cycle CT, executes a simulation based on the target position of an unexecuted cycle process and the model of the articulated robot 10, and estimates an arrival position CP of the end effector 13 in the unexecuted cycle process based on a result of the simulation. The timing estimation unit 114 estimates the movement trajectory R2 based on the estimation result of the arrival position CP, and estimates the command timing T1 based on the estimation result of the movement trajectory R2 as described above. As illustrated in FIG. 4, the command timing T1 is estimated so as to fall within one of the cycle processes, that is, within a time period of the control cycle CT corresponding to the cycle process in which the end effector 13 is expected to reach the processing position EP. The timing estimation unit 114 may sequentially estimate the arrival position CP for a plurality of unexecuted cycle processes, and estimate the movement trajectory R2 based on the estimation results of the plurality of arrival positions CP. Sequentially estimating the arrival position CP for the plurality of unexecuted cycle processes and the robot control unit 112 executing the cycle process for which the arrival position CP has been estimated may be performed in parallel. It is sufficient that at least the estimation of the arrival position CP for each individual cycle process is completed before execution by the robot control unit 112.

The timing estimation unit 114 may execute a simulation of a response delay of each joint 14 of the articulated robot 10 in the unexecuted cycle process based on the model of the articulated robot 10, and estimate the timing based on a result of the simulation of the response delay of each joint 14. Since the timing is estimated taking into account the response delay of each joint 14, the position of the process executed by the end effector 13 can be more accurately controlled.

The response delay of the joint 14 means a delay from when control based on the target angle is started until the joint 14 reaches the target angle. Reaching the target angle may not be limited to completely matching the target angle, but includes approaching the target angle most closely with a slight error remaining. For example, the timing estimation unit 114 calculates a response angle of each joint 14 in which a response delay has occurred with respect to the target angle by the simulation of the response delay, and estimates the above-described arrival position CP by a forward kinematics calculation based on the response angle of each joint 14 and the DH parameters. The timing estimation unit 114 may estimate the above-described arrival position CP taking into account mechanical characteristics such as compliance (or rigidity) of the arm 12.

The timing estimation unit 114 may estimate the command timing T1 in the unexecuted cycle process while the robot control unit 112 is repeating the cycle process based on the plurality of target positions. For example, the timing estimation unit 114 estimates the command timing T1 in the next and subsequent cycle processes while the robot system 1 is executing the cycle process. By limiting the simulation target to the near future during the repetition of the cycle process, computational resources can be saved.

The timing estimation unit 114 may execute a simulation based on the target position of the unexecuted cycle process and the model of the articulated robot 10, estimate a movement speed of the end effector 13 in the unexecuted cycle process based on a result of the simulation, and estimate the command timing based on the estimation result of the movement speed. By basing the estimation on the estimation result of the movement speed of the end effector 13 in the cycle process, the position of the process executed by the end effector 13 during the cycle process can be more accurately controlled.

For example, the timing estimation unit 114 may estimate the movement speed in the unexecuted cycle process based on a difference between the estimation result of the arrival position CP for the unexecuted cycle process and the estimation result of the arrival position CP for the immediately preceding cycle process. For example, the timing estimation unit 114 may estimate the movement speed in the unexecuted cycle process by dividing the above-described difference by the control cycle CT.

The timing estimation unit 114 may estimate the command timing based on the estimation result of the movement speed for each of the plurality of cycle processes when the movement of the end effector 13 to the processing position EP is performed by a series of a plurality of cycle processes up to the unexecuted cycle process. By reflecting the change in movement speed for each cycle process in the estimation result of the command timing, the position of the process executed by the end effector 13 can be more accurately controlled.

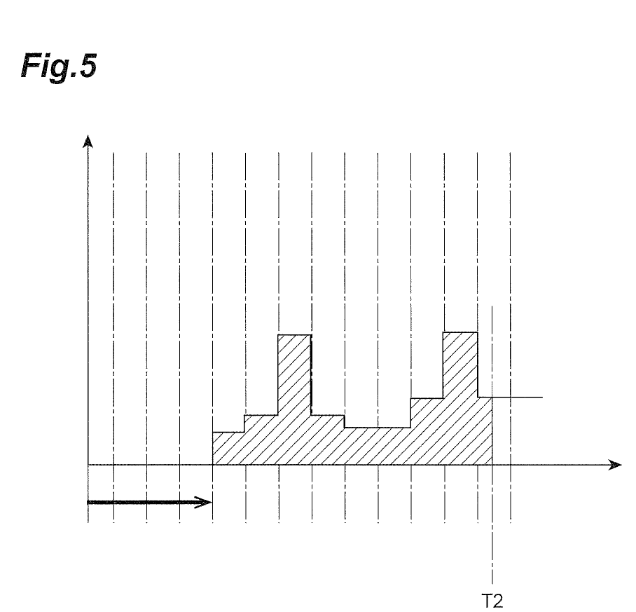

FIG. 5 is a graph representing a relationship between elapsed time and the estimation result of the movement speed. The horizontal axis of FIG. 5 represents elapsed time, and the vertical axis of FIG. 5 represents the movement speed of the end effector 13. For example, the timing estimation unit 114 estimates, as the arrival timing T2, the timing at which the time integral of the movement speed indicated by hatching in FIG. 5 reaches the distance to the processing position EP, and estimates the command timing T1 based on the arrival timing T2.

For example, each time the timing estimation unit 114 estimates the arrival position CP for an unexecuted cycle process, the timing estimation unit 114 estimates the movement speed in that cycle process. Based on the estimated relative movement speed of each of the series of cycle processes, the timing estimation unit 114 estimates a movement distance of the end effector 13 in the unexecuted cycle process. If the end effector 13 does not reach the processing position EP by that cycle process, the timing estimation unit 114 estimates the movement distance to the processing position EP after completion of that cycle process based on the estimation result of the movement speed, and if the end effector 13 reaches the processing position EP by that cycle process, the timing estimation unit 114 may estimate the command timing based on the estimation result of the movement distance and the estimation result of the movement speed.

For example, when the end effector 13 does not reach the processing position EP by the unexecuted cycle process, the timing estimation unit 114 subtracts the integration result of the movement speed in that cycle process from the movement distance to the processing position EP to update the movement distance to the processing position EP. When the end effector 13 reaches the processing position EP by the unexecuted cycle process, the timing estimation unit 114 divides the movement distance by the movement speed to estimate the arrival timing T2.

The target position storage unit 111 may not always store the plurality of target positions. For example, the target position storage unit 111 may temporarily store a plurality of target positions that are dynamically updated. The plurality of target positions may be stored in advance in the target position storage unit 111 at least at the time when the robot control unit 112 starts control based on the plurality of target positions.

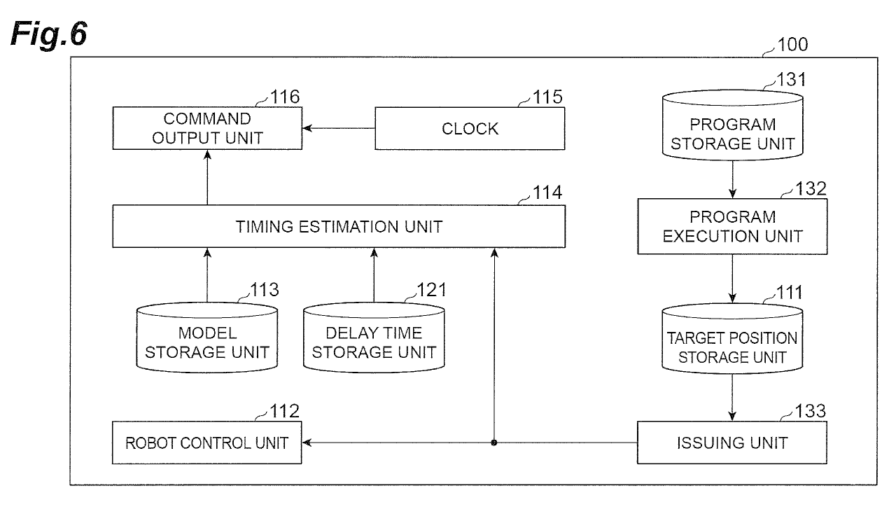

For example, as illustrated in FIG. 6, the robot controller 100 may further include a program storage unit 131 and a program execution unit 132. The program storage unit 131 stores an operation program of the articulated robot 10. The operation program includes a plurality of operation commands arranged in time series. Each of the plurality of operation commands commands movement to a taught position taught in advance at a predetermined movement speed. The taught position may be represented by the position of the end effector 13, or may be represented by the angle of each joint 14.

The program execution unit 132 sequentially executes the plurality of operation commands. For example, the program execution unit 132 calculates a target position for each control cycle based on the taught position of the operation command to be executed, the current position of the robot, and the movement speed, and stores the calculation result in the target position storage unit 111 as the plurality of target positions.

The robot controller 100 may further include an issuing unit 133. The issuing unit 133 sequentially issues the plurality of target positions stored in the target position storage unit 111. The robot control unit 112 repeats the cycle process based on the plurality of target positions issued by the issuing unit 133. The timing estimation unit 114 may estimate the command timing after the issuing unit 133 issues the target position of the unexecuted cycle process and before the robot control unit 112 executes the unexecuted cycle process. By utilizing a time lag from the issuance of the target position to the execution of the cycle process corresponding to that target position, the command timing can be estimated in a timely manner. In addition, by limiting the simulation target to a more limited future scope, computational resources can be further saved.

The delay time storage unit 121 may further store a delay time from the issuance of the target position of the cycle process to the execution of the cycle process (hereinafter referred to as "robot control delay time"). The timing estimation unit 114 may estimate the command timing based on the robot control delay time. By simulation that takes the delay time into account, the position of the process executed by the

end effector 13 can be more accurately controlled. For example, the timing estimation unit 114 estimates the arrival time of the end effector 13 at the arrival position CP based on the time at which the target position of the cycle process corresponding to the arrival position CP was issued (hereinafter referred to as "issuance timing") and the robot control delay time. For example, the timing estimation unit 114 estimates the time that is later than the issuance timing by the robot control delay time as the start time of the cycle process. The timing estimation unit 114 estimates a travel time from the start time of the cycle process to the arrival position CP based on the target position of the cycle process and the simulation model, and adds the estimated travel time to the start time of the cycle process to estimate the arrival time of the end effector 13 at the arrival position CP. For example, the timing estimation unit 114 estimates the arrival timing of the end effector 13 at the arrival position CP through the following sequences. First, the timing estimation unit 114 estimates a start timing of execution of the unexecuted cycle process based on an issuance timing at which the target position of the cycle process corresponding to the arrival position CP was issued and the robot control delay time. For example, the timing estimation unit 114 estimates the timing that is later than the issuance timing by the robot control delay time as the start timing of the cycle process. Next, the timing estimation unit 114 estimates a time length from the start timing to an arrival timing of the end effector 13 at the arrival position CP based on the target position of the cycle process and the simulation model. The timing estimation unit 114 then estimates the command timing T1 based on the estimated start timing and the estimated time length.

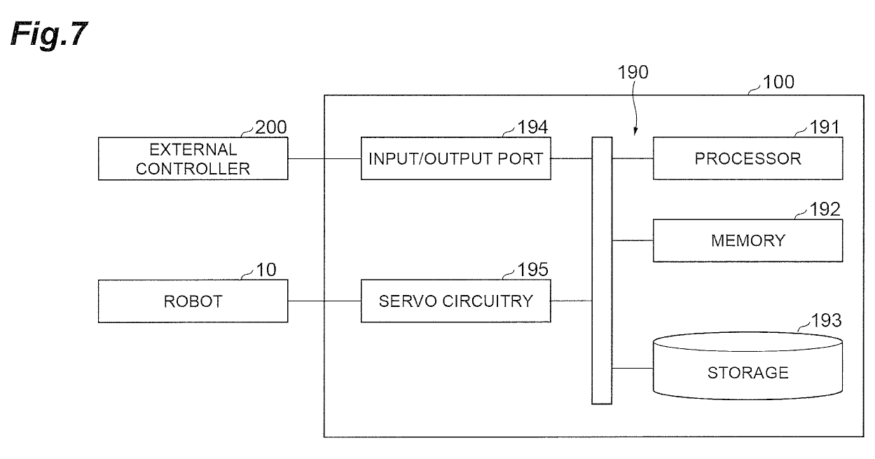

FIG. 7 is a block diagram illustrating a hardware configuration of the robot controller 100. As illustrated in FIG. 7, the robot controller 100 includes circuitry 190. The circuitry 190 includes a processor 191, a memory 192, a storage 193, an input/output port 194, and servo circuitry 195. The storage 193 stores a program for causing the robot controller 100 to execute: controlling the articulated robot 10 based on a plurality of target positions stored in advance; executing a simulation of an unexecuted motion based on at least one of the plurality of target positions and estimating a timing for outputting an execution command of the process based on a result of the simulation (hereinafter referred to as "command timing"); and outputting the execution command based on the estimated command timing. For example, the storage 193 stores a program for causing the robot controller 100 to configure the functional blocks described above. The storage 193 includes one or more non-volatile storage devices. Examples of non-volatile storage devices include a hard disk drive, a flash memory, an optical disk drive, a read-only memory, and the like.

The memory 192 temporarily stores a program loaded from the storage 193. The memory 192 includes one or more volatile storage devices. Examples of volatile storage devices include a random access memory and the like. The processor 191 causes the robot controller 100 to configure the functional blocks described above by executing the program loaded into the memory 192. The processor 191 includes one or more processing units. Examples of processing units include a CPU (Central Processing Unit) and the like.

The input/output port 194 performs input and output of information with the external controller 200 and the like based on a request from the processor 191. The servo circuitry 195 supplies driving power for each of the plurality of joints 14 to the articulated robot 10 based on a request from the processor 191.

In the above, an example has been shown in which the articulated robot 10 moves the end effector 13 relative to the workpiece by moving the end effector 13, but the present disclosure is not limited to this. For example, the articulated robot 10 may be configured to move the end effector 13 relative to the workpiece by moving the workpiece. The articulated robot 10 has a holding unit (for example, a suction holding unit or a hand) that holds the workpiece, instead of the end effector 13. The end effector 13 is provided in surrounding area of the articulated robot 10.

The robot system 1 may individually include a first articulated robot 10 that moves the end effector 13 and a second articulated robot 10 that moves the workpiece. The first articulated robot 10 and the second articulated robot 10 cooperate to move the end effector 13 relative to the workpiece. The timing estimation unit 114 may execute simulations of unexecuted motions by each of the first articulated robot 10 and the second articulated robot, and estimate the command timing based on the results of the simulations.

### Control Procedure

As an example of the control method, a control procedure for the articulated robot 10 and the end effector 13 executed by the control system 2 is illustrated. This procedure includes controlling the articulated robot 10 based on a plurality of target positions stored in advance so as to move the end effector 13 relative to the workpiece, executing a simulation of an unexecuted motion based on at least one of the plurality of target positions and estimating a command timing for outputting an execution command of the process based on a result of the simulation, outputting the execution command based on the estimated command timing, and causing the end effector 13 to execute the process in response to the execution command. Hereinafter, this procedure is illustrated separately as a control procedure for the articulated robot 10, a control procedure for the joint 14, an estimation procedure for the command timing, an output procedure for the execution command, and a control procedure for the end effector 13.

### Control Procedure for Articulated Robot

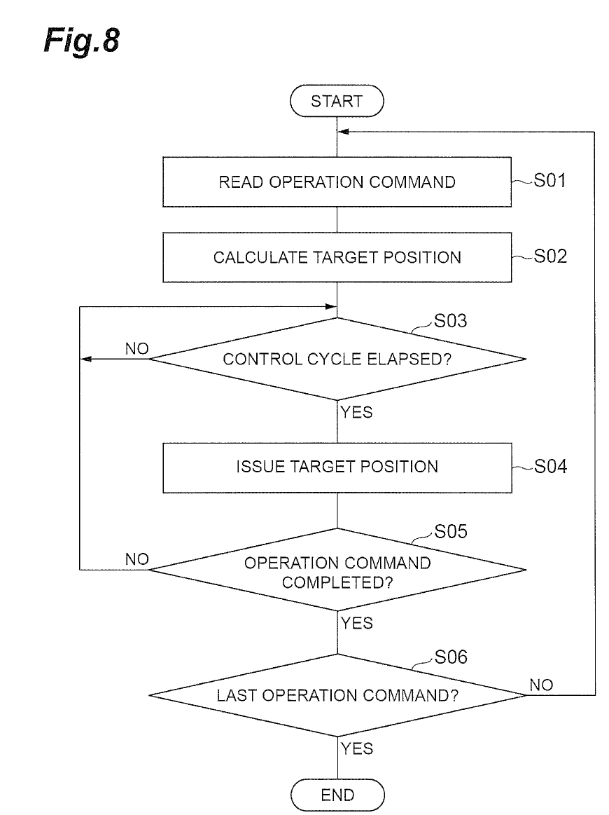

As illustrated in FIG. 8, the robot controller 100 sequentially executes operations S01 and S02. In operation S01, the program execution unit 132 reads out the next operation command to be executed (hereinafter referred to as "command to be executed") from the program storage unit 131. In operation S02, the program execution unit 132 calculates a target position for each control cycle based on the taught position of the command to be executed, the current position of the robot, and the movement speed, and stores the calculation results in the target position storage unit 111 as the plurality of target positions. Next, the robot controller 100 sequentially executes operations S03 and S04. In operation S03, the issuing unit 133 waits for the elapse of the control cycle. In operation S04, the issuing unit 133 issues the target position at the head of the time series among the plurality of target positions stored in the target position storage unit 111. The issuing unit 133 deletes the issued target position from the target position storage unit 111.

Next, the robot controller 100 executes operation S05. In operation S05, the issuing unit 133 confirms whether the execution of the command to be executed has been completed (whether all of the plurality of target positions calculated in operation S02 have been issued). If it is determined in operation S05 that the execution of the command to be executed has not been completed, the robot controller 100 returns the process to operation S03. Thereafter, the issuance of the target position is repeated at the control cycle until the execution of the command to be executed is completed. If it is determined in operation S05 that the execution of the command to be executed has been completed, the robot controller 100 executes operation S06. In operation S06, the program execution unit 132 confirms whether the completed command to be executed was the last operation command. If it is determined in operation S06 that the completed command to be executed was not the last operation command, the robot controller 100 returns the process to operation S01. If it is determined in operation S06 that the completed command to be executed was the last operation command, the control procedure for the articulated robot 10 is completed.

### Control Procedure for Joint

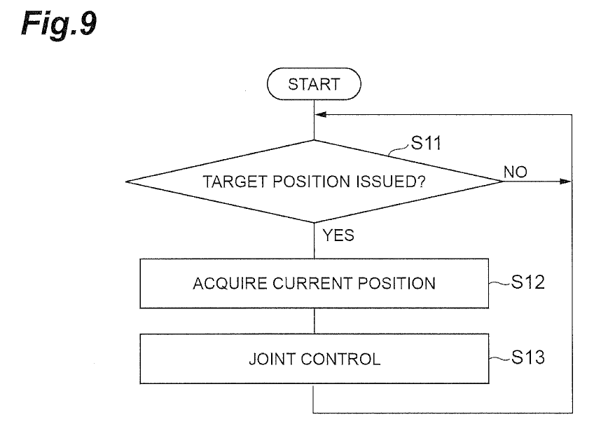

As illustrated in FIG. 9, the robot controller 100 sequentially executes operations S11, S12, and S13. In operation S11, the robot control unit 112 waits for the target position to be issued by the issuing unit 133. In operation S12, the robot control unit 112 acquires a detection result of the current position of the articulated robot 10 (for example, the current angle of each joint 14). In operation S13, the robot control unit 112 controls each joint 14 so as to bring the current position closer to the target position. For example, the robot control unit 112 generates driving power so as to bring the current position closer to the target position, and supplies the driving power to each joint 14. Thereafter, the robot controller 100 returns the process to operation S11. The robot controller 100 repeatedly executes the above procedure.

### Estimation Procedure for Command Timing

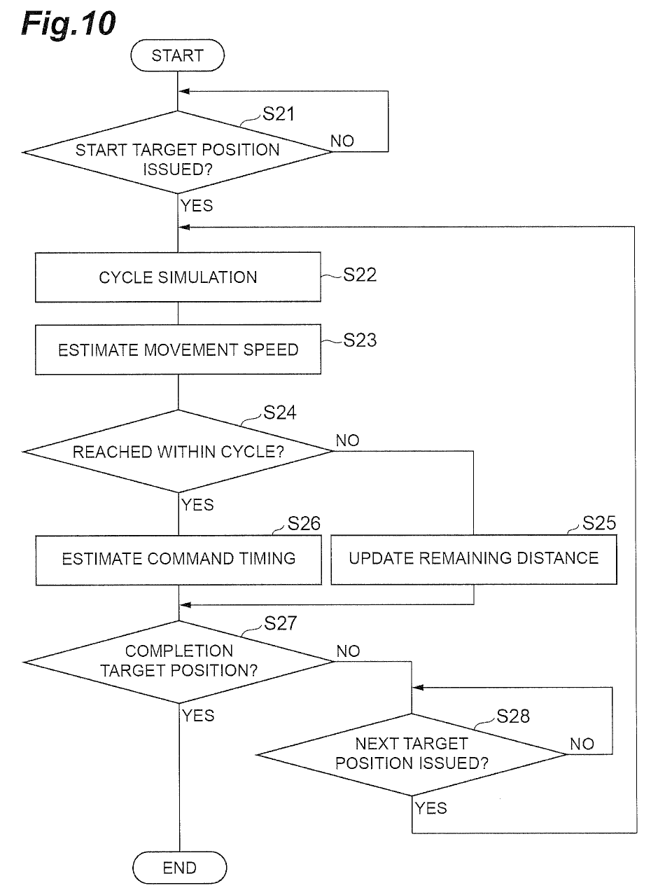

This procedure is executed during the execution of the control procedure illustrated in FIG. 9. As illustrated in FIG. 10, the robot controller 100 first executes operations S21, S22, and S23. In operation S21, the timing estimation unit 114 waits for the issuing unit 133 to issue a start target position (a predetermined target position for starting the simulation). In operation S22, the timing estimation unit 114 executes a simulation of the motion of the articulated robot 10 in the cycle process corresponding to the issued target position, based on the end effector control delay time (the delay time from the output of the execution command to the execution of the process by the end effector 13), the robot control delay time, the simulation model of the articulated robot 10, and the target position of the unexecuted cycle process. Hereinafter, the cycle process corresponding to the issued target position is referred to as "unexecuted cycle process." The timing estimation unit 114 estimates the arrival position CP of the end effector 13 by the unexecuted cycle process based on the result of the simulation. In operation S23, the timing estimation unit 114 estimates the movement speed of the end effector 13 in the unexecuted cycle process based on the estimation result of the arrival position CP.

Next, the robot controller 100 executes operation S24. In operation S24, the timing estimation unit 114 confirms whether the end effector 13 reaches the processing position EP by the unexecuted cycle process. For example, the timing estimation unit 114 confirms whether the end effector 13 reaches the processing position EP based on the positional relationship between the arrival position CP and the processing position EP. If it is determined in operation S24 that the end effector 13 does not reach the processing position EP, the robot controller 100 executes operation S25. In operation S25, the timing estimation unit 114 estimates the remaining distance (movement distance to the next processing position EP) after completion of the unexecuted cycle process based on the estimation result of the movement speed. If it is determined in operation S24 that the end effector 13 reaches the processing position EP, the robot controller 100 executes operation S26. In operation S26, the timing estimation unit 114 estimates the command timing T1 based on the movement distance to the processing position EP and the movement speed.

Next, the robot controller 100 executes operation S27. In operation S27, the timing estimation unit 114 confirms whether the target position is a completion target position (a predetermined target position for completing the simulation). If it is determined in operation S27 that the target position is not the completion target position, the robot controller 100 executes operation S28. In operation S28, the timing estimation unit 114 waits for the issuance of the next target position. Thereafter, the robot controller 100 returns the process to operation S22. Thereafter, until the target position becomes the completion target position, the estimation of the arrival position CP and the estimation of the remaining distance or the command timing T1 are repeated for each target position. If it is determined in operation S27 that the target position is the completion target position, the estimation procedure for the command timing is completed.

### Execution Command Output Procedure

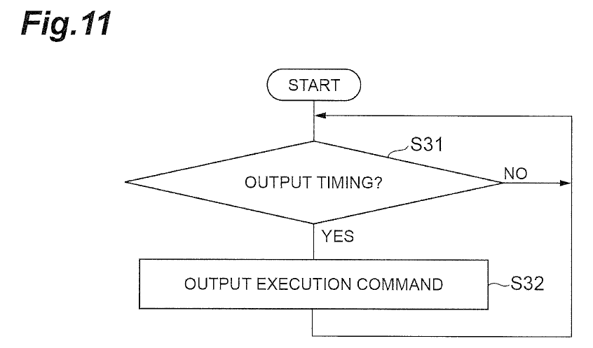

This procedure is executed during the execution of the control procedure illustrated in FIG. 9. As illustrated in FIG. 11, the robot controller 100 executes operations S31 and S32. In operation S31, the command output unit 116 waits for the elapsed time to reach the command timing T1. In operation S32, the command output unit 116 outputs the execution command. Thereafter, the robot controller 100 returns the process to operation S31. The robot controller 100 repeatedly executes the above process.

### Control Procedure for End Effector

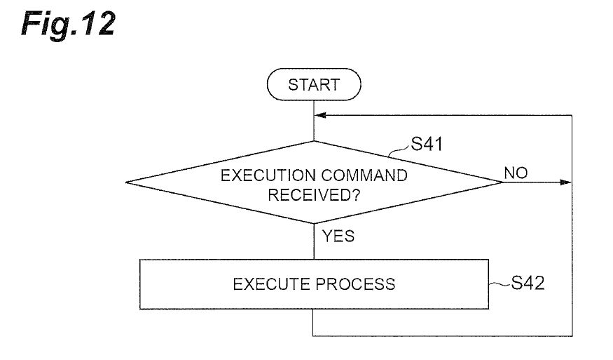

This procedure is executed during the execution of the control procedure illustrated in FIG. 9. As illustrated in FIG. 12, the external controller 200 executes operations S41 and S42. In operation S41, the external controller 200 waits for the execution command to be output. In operation S42, the external controller 200 causes the end effector 13 to execute the process. Thereafter, the external controller 200 returns the process to operation S41. The external controller 200 repeatedly executes the above process.

### Conclusion

The above disclosure includes the following configurations.

(1) A robot system 1 including: an articulated robot 10 configured to move an end effector 13 configured to execute a predetermined process; a robot control unit 112 configured to control the articulated robot 10 based on a plurality of target positions stored in advance; a timing estimation unit 114 configured to execute a simulation of an unexecuted motion by the articulated robot 10 based on at least one of the plurality of target positions and estimate a timing for outputting an execution command of the process based on a result of the simulation; a command output unit 116 configured to output the execution command based on the timing estimated by the timing estimation unit 114; and an end effector control unit configured to cause the end effector 13 to execute the process in response to the execution command.

When causing the end effector 13 to execute the process after detecting that the end effector 13 has reached a position at which the process is desired to be executed, a delay may occur between the timing at which the end effector 13 actually reaches that position and the timing at which the process is executed. Due to this delay, there is a possibility that the position of the process executed by the end effector 13 cannot be accurately controlled. With this robot system 1, before the end effector 13 reaches the position at which the process is desired to be executed, the timing for outputting the execution command of the process is estimated by simulation, and the execution command is output based on the estimated timing. Therefore, the position of the process executed by the end effector 13 can be more accurately controlled.

(2) The robot system 1 according to (1), wherein the timing estimation unit 114 is configured to estimate the timing for outputting the execution command so that an error between a position at which the process is executed by the end effector 13 and a predetermined processing position is reduced.

By predetermining the processing position, the position at which the process is executed can be controlled.

(3) The robot system 1 according to (1) or (2), further including a storage unit 121 configured to store a delay time from an output of the execution command to an execution of the process by the end effector 13, wherein the timing estimation unit 114 is configured to estimate the timing further based on the delay time.

A deviation in the position at which the process is executed by the end effector 13 can be further suppressed.

(4) The robot system 1 according to any one of (1) to (3), wherein the robot control unit 112 is configured to execute a cycle process for controlling the articulated robot 10 based on each of the plurality of target positions, and the timing estimation unit 114 is configured to execute a simulation based on the target position of an unexecuted cycle process and a model of the articulated robot 10, and estimate the timing in the unexecuted cycle process based on a result of the simulation.

Since the timing can be estimated by executing a simulation of future behavior for each cycle process, the position of the process executed by the end effector 13 can be more accurately controlled.

(5) The robot system 1 according to (4), wherein the timing estimation unit 114 is configured to: execute a simulation of a response delay of each joint of the articulated robot 10 in the unexecuted cycle process based on the model of the articulated robot 10; and estimate the timing based on a result of the simulation of the response delay of each joint.

Since the timing is estimated taking into account the response delay of each joint, the position of the process executed by the end effector 13 can be more accurately controlled.

(6) The robot system 1 according to (4) or (5), wherein the timing estimation unit 114 is configured to estimate the timing in the unexecuted cycle process while the robot control unit 112 is repeating the cycle process based on the plurality of target positions.

By limiting the simulation target to the near future during the repetition of the cycle process, computational resources can be saved.

(7) The robot system 1 according to (6), further including an issuing unit 133 configured to sequentially issue the plurality of target positions, wherein the robot control unit 112 is configured to repeat the cycle process based on the plurality of target positions issued by the issuing unit 133, and the timing estimation unit 114 is configured to estimate the timing after the issuing unit 133 issues the target position of the unexecuted cycle process and before the robot control unit 112 executes the unexecuted cycle process.

By utilizing the time lag from the issuance to the cycle process, the timing can be estimated in a timely manner.

(8) The robot system 1 according to (7), further including a storage unit 121 configured to store a delay time from an issuance of the target position of the cycle process to an execution of the cycle process, wherein the timing estimation unit 114 is configured to estimate the timing further based on the delay time.

By simulation that takes the delay time into account, the position of the process executed by the end effector 13 can be more accurately controlled.

(9) The robot system 1 according to any one of (4) to (8), wherein the timing estimation unit 114 is configured to: execute a simulation based on the target position of the unexecuted cycle process and the model of the articulated robot 10, and estimate a movement speed of the end effector 13 in the unexecuted cycle process based on a result of the simulation; and estimate the timing based on an estimation result of the movement speed.

By basing the estimation on the estimation result of the movement speed of the end effector 13 in the cycle process, the position of the process executed by the end effector 13 during the cycle process can be more accurately controlled.

(10) The robot system 1 according to (9), wherein the timing estimation unit 114 is configured to, when a movement of the end effector 13 to the position at which the process is executed is executed by a series of a plurality of cycle processes up to the unexecuted cycle process, estimate the timing based on the estimation result of the movement speed for each of the plurality of cycle processes.

By reflecting the change in movement speed for each cycle process in the estimation result of the timing, the position of the process executed by the end effector 13 can be more accurately controlled.

(11) The robot system 1 according to (9) or (10), wherein the timing estimation unit 114 is configured to, in a case where the end effector 13 does not reach the position at which the process is executed by the unexecuted cycle process, estimate the movement distance to the position at which the process is executed after completion of the unexecuted cycle process based on the estimation result of the movement speed, and in a case where the end effector 13 reaches the position at which the process is executed by the unexecuted cycle process, estimate the timing based on the estimation result of the movement distance and the estimation result of the movement speed.

By reflecting the change in movement speed for each cycle process in the estimation result of the timing, the position of the process executed by the end effector 13 can be more accurately controlled.

(12) The robot system 1 according to (2), wherein the timing estimation unit 114 is configured to estimate the timing for each of a plurality of processing positions arranged at equal intervals, and the command output unit is configured to output the execution command based on the timing estimated for each of the plurality of processing positions.

The magnitude of the deviation of the position at which the end effector 13 actually executes the process (hereinafter referred to as "execution position") with respect to the processing position varies due to the delay described above and due to the movement speed of the end effector 13, so the magnitude of the deviation may vary for each processing position. For this reason, even if the plurality of processing positions are arranged at equal intervals, the intervals between the plurality of execution positions may vary. With this robot controller, which can reduce the delay from the timing at which the end effector 13 reaches the processing position to the timing at which the process is executed, variation in the intervals between the plurality of execution positions can be suppressed.

(13) A robot controller including: a robot control unit 112 configured to control an articulated robot 10 based on a plurality of target positions stored in advance so as to move an end effector 13 that executes a predetermined process; a timing estimation unit 114 configured to execute a simulation of an unexecuted motion by the articulated robot 10 based on at least one of the plurality of target positions, and estimate a timing for outputting an execution command of the process based on a result of the simulation; and a command output unit 116 configured to output the execution command based on the timing estimated by the timing estimation unit 114.

(14) A control method including: controlling an articulated robot 10 based on a plurality of target positions stored in advance so as to move an end effector 13 that executes a predetermined process; executing a simulation of an unexecuted motion by the articulated robot 10 based on at least one of the plurality of target positions and estimating a timing for outputting an execution command of the process based on a result of the simulation; and outputting the execution command based on the estimated timing.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A robot system comprising:
an articulated robot configured to move, relative to a workpiece, an end effector configured to execute a predetermined process on the workpiece;
circuitry configured to:
control the articulated robot based on a plurality of target positions stored in advance;
execute a simulation of an unexecuted motion by the articulated robot based on at least one of the plurality of target positions, and estimate a timing for outputting an execution command of the process based on a result of the simulation;
output the execution command based on the estimated timing; and
cause the end effector to execute the process in response to the execution command.

2. The robot system according to claim 1, wherein the circuitry is configured to estimate the timing for outputting the execution command so that an error between an actual execution position of the process according to the execution command and a predetermined processing position is reduced compared with a case where the execution command is output in response to an actual arrival of the end effector to the processing position.

3. The robot system according to claim 2, wherein the circuitry is further configured to estimate the timing so that the timing is before the actual arrival of the end effector to the processing position.

4. The robot system according to claim 1, wherein the circuitry is further configured to:
store a delay time from an output of the execution command to an execution of the process by the end effector; and
estimate the timing further based on the delay time.

5. The robot system according to claim 4, wherein the circuitry is configured to estimate the timing so that a length of time from the timing to the actual arrival corresponds to the delay time.

6. The robot system according to claim 1, wherein the circuitry is configured to:
sequentially execute a plurality of cycle processes respectively corresponding to the plurality of target positions to control the articulated robot;
execute a simulation based on a target position of an unexecuted cycle process and a model of the articulated robot; and
estimate, based on a result of the simulation, the timing so that the timing is within the unexecuted cycle process.

7. The robot system according to claim 6, wherein the circuitry is configured to:
estimate, based on a result of the simulation, a relationship between an elapsed time and a position of the end effector in the unexecuted cycle process; and
estimate, based on the estimated relationship, the timing so that the timing is within the unexecuted cycle process.

8. The robot system according to claim 6, wherein the circuitry is configured to:
execute a simulation of a response delay of each joint of the articulated robot in the unexecuted cycle process based on the model of the articulated robot; and
estimate the timing based on a result of the simulation of the response delay of each joint.

9. The robot system according to claim 8, wherein the circuitry is configured to:
estimate, based on a result of the simulation including the simulated response delay, a relationship between an elapsed time and a position of the end effector in the unexecuted cycle process; and
estimate, based on the estimated relationship, the timing so that the timing is within the unexecuted cycle process.

10. The robot system according to claim 6, wherein the circuitry is configured to estimate the timing in the unexecuted cycle process while sequentially executing the plurality of cycle processes based on the plurality of target positions.

11. The robot system according to claim 10, wherein the circuitry is further configured to:
sequentially issue the plurality of target positions;
sequentially execute the plurality of cycle processes based on the issued plurality of target positions; and
estimate the timing after the target position of the unexecuted cycle process is issued and before the unexecuted cycle process is executed.

12. The robot system according to claim 11, wherein the circuitry is further configured to:
store a delay time from an issuance of the target position of the cycle process to an execution of the cycle process; and
estimate the timing further based on the delay time.

13. The robot system according to claim 12, wherein the circuitry is configured to:
estimate a start timing of execution of the unexecuted cycle process based on the delay time and an issuance timing of the unexecuted cycle process;
estimate, based on a result of the simulation, a time length from the start timing to an arrival timing of the end effector at an execution position of the process; and
estimate the timing based on the estimated start timing and the estimated time length.

14. The robot system according to claim 6, wherein the circuitry is configured to:
execute the simulation based on the target position of the unexecuted cycle process and the model of the articulated robot;
estimate, based on a result of the simulation, a relative movement speed of the end effector with respect to the workpiece in the unexecuted cycle process; and
estimate the timing based on the estimated relative movement speed.

15. The robot system according to claim 14, wherein the circuitry is configured to:
estimate, based on the result of the simulation, a movement distance to the position at which the process is executed in the unexecuted cycle process; and
estimate the timing based on the estimated movement distance and the estimated relative movement speed.

16. The robot system according to claim 6, wherein the circuitry is configured to:
execute the simulation based on target positions of a series of cycle processes up to the unexecuted cycle process and a model of the articulated robot;
estimate, based on a result of the simulation, a relative movement speed of the end effector with respect to the workpiece for each of the series of cycle processes; and
estimate the timing based on the estimated relative movement speed for each of the series of cycle processes.

17. The robot system according to claim 16, wherein the circuitry is configured to:
estimate, based on the estimated relative movement speed of each of the series of cycle processes, a movement distance of the end effector in the unexecuted cycle process; and
estimate the timing based on the estimated movement distance and the estimated relative movement speed of the unexecuted cycle process.

18. The robot system according to claim 2, wherein the circuitry is configured to:
estimate the timing for each of a plurality of processing positions arranged at equal intervals; and
output the execution command based on the timing estimated for each of the plurality of processing positions.

19. A robot controller comprising circuitry configured to:
control an articulated robot based on a plurality of target positions stored in advance so as to move, relative to a workpiece, an end effector that executes a predetermined process on the workpiece;
execute a simulation of an unexecuted motion by the articulated robot based on at least one of the plurality of target positions, and estimate a timing for outputting an execution command of the process based on a result of the simulation; and
output the execution command based on the estimated timing.

20. A control method comprising:
controlling an articulated robot based on a plurality of target positions stored in advance so as to move, relative to a workpiece, an end effector that executes a predetermined process on the workpiece;
executing a simulation of an unexecuted motion by the articulated robot based on at least one of the plurality of target positions, and estimating a timing for outputting an execution command of the process based on a result of the simulation; and
outputting the execution command based on the estimated timing.
